(19) United States
(12) Patent Application Publication
(10) Pub. No.: US 2026/0039575 A1
(43) Pub. Date: Feb. 5, 2026

(54) TRACING OF GROUP-BASED POLICY IDENTIFIERS

(71) Applicant: HEWLETT PACKARD ENTERPRISE DEVELOPMENT LP, Spring, TX (US)

(72) Inventors: Suresh Kumar Reddy Beeram, Bangalore (IN); V N S Ramaprasad Allu, Bangalore (IN)

(21) Appl. No.: 18/911,844

(22) Filed: Oct. 10, 2024

(30) Foreign Application Priority Data
Jul. 30, 2024 (IN) 202441057710

(51) Int. Cl. H04L 43/10; H04L 12/46; H04L 45/74; H04L 45/76

(52) U.S. Cl. CPC H04L 43/10; H04L 12/4633; H04L 45/74; H04L 45/76

(57) ABSTRACT

In some examples, a first network device in a first domain sends, to a first gateway device of the first domain, a trace packet targeted to a destination device in a second domain, the trace packet including a first virtual tunnel header and a probe request, the first virtual tunnel header containing a first policy identifier. The first network device receives a response packet including a second virtual tunnel header and probe information, the probe information containing a translated policy identifier field to store any translated policy identifier produced by a second gateway device of the second domain. The first network device initiates an update of a trace record by adding a policy identifier contained in the translated policy identifier field to support diagnostics relating to a policy identifier mistranslation.

### BACKGROUND

A network environment can be partitioned into domains in which entities are able to communicate with one another over a network. Each domain has a gateway device that connects over an interconnect to another gateway device of another domain. Traffic between entities in different domains is passed through respective gateway devices of the different domains.

### BRIEF DESCRIPTION OF THE DRAWINGS

Some implementations of the present disclosure are described with respect to the following figures.

FIG. 1 is a block diagram of a network environment including multiple domains, according to some examples.

FIG. 2A to FIG. 2C are block diagrams of an example of tracing group-based policy identifiers (GBP IDs), according to some examples.

FIG. 3 is a block diagram of a storage medium storing machine-readable instructions according to some examples.

FIG. 4 is a block diagram of a network device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Entities (e.g., users, programs, or machines) that perform communications in a network environment may be assigned to different groups. The different groups of entities are associated with different group-based policies. A group-based policy can include a security policy that specifies resources that entities of a given group are permitted to access, or actions that such entities may take. A group-based policy may also specify other rules that govern operations of entities. Group-based policies are assigned identifiers, which are referred to as group-based policy identifiers (GBP IDs).

A network environment may include multiple different domains, such as different data centers, different campuses, different geographic sites, communication fabrics, or any other types of domains. In a multi-domain environment, the allocation and management of GBP IDs may be performed independently in the different domains, and as a result, a given group-based policy may be assigned different GBP IDs in the different domains. For example, a first domain may assign a first GBP ID to the given group-based policy, while a second domain may assign a different second GBP ID to the given group-based policy. Note that it is also possible that different domains may assign the same GBP ID to a particular group-based policy.

To support the use of different GBP IDs by different domains for the same group-based policy, GBP ID translation can be performed at gateway devices of the domains. A network administrator or orchestration system may program GBP ID translation rules in the gateways. The following example scenarios may result in incorrect translations of GBP IDs. A first scenario involves mis-programming of a translation rule at a gateway device, in which an incorrect translation rule is configured in the gateway device. A second scenario involves data errors or program errors at the gateway device causing a mistranslation of a GBP ID. A third scenario involves a failure to update a translation rule to reflect a changed GBP ID. Using incorrect GBP IDs due to incorrect translations can lead to communication errors or a security breach in which an entity is permitted to access a resource or take an action when in fact the entity is not permitted to do so. For example, a policy enforcement device may apply a wrong group-based policy as a result of a GBP ID mistranslation, which may permit a packet from a source entity to pass to a destination device when the correct group-based policy would have specified that the packet should be dropped.

It can be difficult for an operator of the network environment to detect issues (e.g., communication errors or faults, security breaches, etc.) associated with GBP ID mistranslations. Thus, the network environment may be compromised without the operator being aware of a communication error or a security breach caused by a GBP ID mistranslation. Additionally, even if communication errors due to GBP ID mistranslations are detected, it can be difficult for the operator to identify the source(s) of the communication errors.

In accordance with some implementations of the present disclosure, GBP ID tracing is provided to track GBP IDs at various nodes in a data path of a virtual tunnel between an ingress edge network device and an egress edge network device, where the tracking is accomplished using trace packets and response packets sent in response to the trace packets. The tracking produces a trace record including the GBP IDs at the various nodes in the data path of the virtual tunnel. The trace record can be used to detect a GBP ID mistranslation and application of a wrong policy action, and a system can trigger a remediation action in response to the detection of the GBP ID mistranslation and an associated application of the wrong policy action. The remediation action can include isolating a particular node or segment of a network environment, or any other remediation action to fix communication errors or to protect against a potential security breach.

The GBP ID tracing includes an ingress edge network device in a first domain sending to a first gateway device of the first domain, a trace packet targeted to a destination device in a second domain. The trace packet includes a first virtual tunnel header and a probe request. The first virtual tunnel header contains a first GBP ID, and the probe request initiates the GBP ID tracing. The GBP ID tracing further includes receiving, at the ingress edge network device, a response packet including a second virtual tunnel header and probe information. The probe information contains a translated GBP ID field to store any translated GBP ID produced by an egress gateway device of the second domain. The ingress edge gateway device and the egress gateway device are in a data path of a virtual tunnel between the ingress edge network device in the first domain and the egress edge network device in the second domain. The GBP ID tracing further includes updating a trace record by adding a GBP ID contained in the translated GBP ID field.

Although some examples of the present disclosure refer to tracing GBP IDs, in other examples, techniques or mechanisms of the present disclosure can be used to trace other types of policy identifiers that identify polices to use for handling or processing packets. A policy can include one or more rules governing the handling or processing of packets.

A “probe request” is an indicator that specifies that a probing process is to start. The probing process in some examples of the present disclosure is part of GBP ID tracing. “Probe information” includes values that are used to represent the following: a GBP ID used at a given node in a data path of a virtual tunnel, an indicator that a trace packet has reached an egress edge network device, and a policy action taken by the egress edge network device according to a group-based policy identified by a GBP ID included in a trace packet.

An “ingress edge network device” can refer to an edge network device connected to a source endpoint device that transmits information targeted to a destination endpoint device. An “egress edge network device” can refer to an edge network device connected to the destination endpoint device. Note that a network device may be an ingress edge network device for some communication flows, but an egress edge network device for other communication flows. Examples of endpoint devices include desktop computers, notebook computers, tablet computers, server computers, storage systems, communication notes, or other electronic devices capable of transmitting or receiving information over a network.

In some examples, the virtual tunnel between the ingress edge network device and the egress edge network device is a Virtual Extensible Local Area Network (VXLAN) tunnel. According to the VXLAN protocol, the VXLAN tunnel encapsulates Layer 2 frames of a Layer 2 overlay network as payloads in Layer 3 packets. The Layer 3 packets are communicated through a Layer 3 underlay network. A network in which frames of a Layer 2 overlay network are carried in a Layer 3 underlay network is referred to as an “underlay and overlay network.” A network device, such as a switch or another type of network device that forwards data, can include a data plane entity that performs VXLAN encapsulation and decapsulation. Such a data plane entity is referred to as a VXLAN tunnel endpoint (VTEP). The VTEP is part of the data plane of the underlay and overlay network used for forwarding of data by the network device. The network device also includes a control plane entity (that is part of the control plane of the underlay and overlay network) that exchanges control information with other network devices to enable forwarding of data by the network devices. In some examples, the control plane of the underlay and overlay network can operate according to the Ethernet Virtual Private Network (EVPN) technology.

In examples that implement EVPN and VXLAN, the different domains of a network environment can include different EVPN domains. Although reference is made to EVPN and VXLAN in some examples for establishing virtual tunnels between network devices, it is noted that in other examples, other types of virtual tunnel technologies may be employed, whether open source, standardized, or proprietary. Examples of other virtual tunnel technologies include the following: a Multiprotocol Label Switching (MPLS)-over-Generic Routing Encapsulation (GRE) technology, a Network Virtualization using GRE (NVGRE) technology, or any other technology for establishing virtual tunnels.

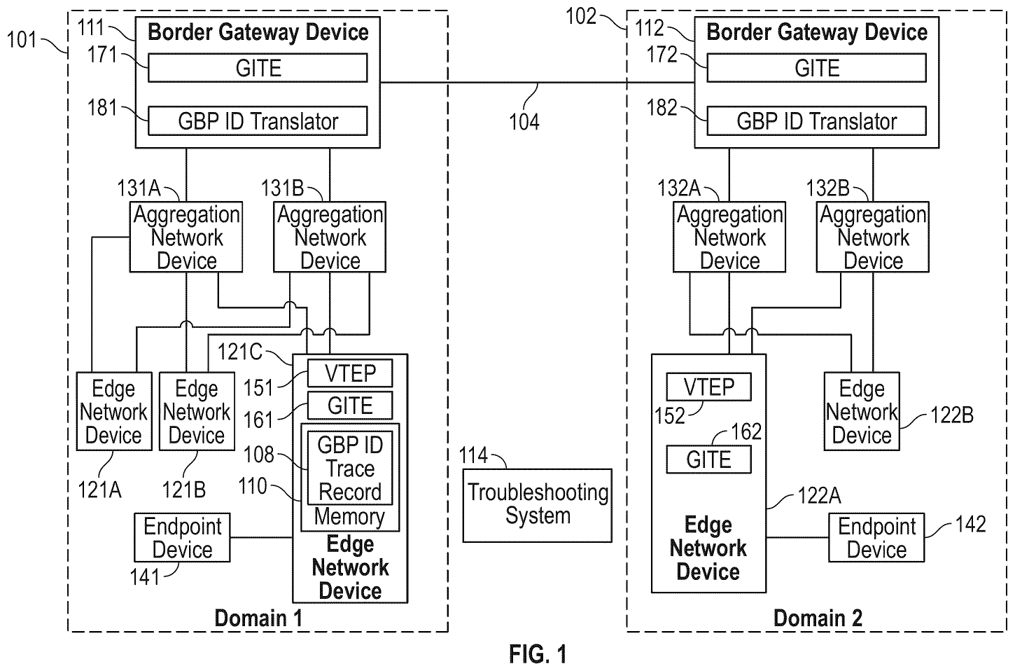

FIG. 1 is a block diagram of a network environment that includes two domains, a domain 101 and a domain 102. In other examples, a network environment may include more than two domains. The domain 101 includes a border gateway device 111, and the domain 102 includes a border gateway device 112. A “border gateway device” can refer to any network device that supports communications between different domains. In some examples, a border gateway device can operate according to a Border Gateway Protocol (BGP), which supports routing among different domains. Each domain further includes other types of network devices. A network device refers to a device that supports forwarding of data along data paths of a network. A network device that is connected to one or more endpoint devices is referred to as an edge network device. Edge network devices can include access network devices (e.g., access points), leaf network devices (edge switches), or any other types of network devices connected to endpoint devices. In the example of FIG. 1, the domain 101 includes edge network devices 121A, 121B, and 121C.

In the example of FIG. 1, the edge network device 121C is connected to an endpoint device 141. Additional endpoint devices may be connected to the edge network device 121C. Each of the other edge network devices 121A and 121B can be connected to one or more endpoint devices (not shown).

Intermediate network devices (also referred to as “aggregation network devices”) can be provided between edge network devices and other network devices, such as a border gateway device. In the example of FIG. 1, aggregation network devices 131A and 131B are connected between the edge network devices 121A, 121B, 121C and the border gateway device 111. In other examples, aggregation network devices may be omitted.

The border gateway device 111 is connected to the border gateway device 112 over an interconnect 104. In examples where the domains 101 and 102 are data centers, the interconnect 104 can be referred to as a data center interconnect (DCI). More generally, the interconnect 104 can refer to any communication link to connect domains.

The domain 102 includes edge network devices 122A and 122B. The edge network device 122A is connected to an endpoint device 142 (and possibly to one or more other endpoint devices). The edge network device 122B can also be connected to one or more endpoint devices (not shown). Aggregation network devices 132A and 132B are connected between the edge network devices 122A, 122B and the border gateway device 112.

FIG. 1 shows example components of the edge network devices 121C and 122A. The other edge network devices in the domains 101 and 102 can include similar components.

The network environment of FIG. 1 includes an underlay and overlay network, in which an overlay network (an L2 network) is provided over an underlay network, which is an L3 network such as an Internet Protocol (IP) network. The overlay network includes a control plane (e.g., that operates according to the EVPN technology) and a data plane that includes tunnels (e.g., VXLAN tunnels).

A tunnel, such as a VXLAN tunnel, can be established between edge network devices, such as between a VTEP 151 in the edge network device 121C and a VTEP 152 in the edge network device 122A. The VTEPs are part of the data plane. As noted above, a VTEP can perform VXLAN encapsulation and decapsulation of packets sent between the edge network devices 121C and 122A. In an example, the endpoint device 141 transmits, to the edge network device 121C, a packet targeted to the endpoint device 142. In response to receipt of the packet, the VTEP 151 in the (ingress) edge network device 121C performs VXLAN encapsulation of the packet by adding a VXLAN header, and sends the encapsulated packet over the VXLAN tunnel to the (egress) edge network device 122A. Nodes in the data path of the VXLAN tunnel between the VTEP 151 and the VTEP 152 include the aggregation network device 131A or 131B, the border gateway device 111, the border gateway device 112, and the aggregation network device 132A or 132B. The VTEP 152 decapsulates the encapsulated packet by removing the VXLAN header. Based on a group-based policy applicable to the packet, the edge network device 122A can either forward the decapsulated packet to the endpoint device 142, drop the decapsulated packet, or perform another action with respect to the decapsulated packet.

The network devices (including edge network devices, aggregation network devices, and border gateway devices) also includes a control plane, which can be implemented using controllers in the respective network devices. The controllers can operate according to EVPN in some examples. The controllers perform control functionalities that support the forwarding of packets of the overlay network.

EVPN is a standards-based technology that provides virtual multipoint bridged connectivity between different Layer 2 domains over a Layer 3 underlay network. EVPN is an extension to the BGP that allows the network to carry endpoint reachability information such as Layer 2 MAC addresses and Layer 3 IP addresses. According to EVPN, the Layer 2 overlay network (referred to as an EVPN-VXLAN overlay network) overlays an IP network. The controllers that operate according to EVPN can exchange reachability information so that VTEPs can interact with one another.

In other examples, controllers of network devices for implementing the control plane can operate according to other control protocols, whether standardized, open source, or proprietary.

Each border gateway device also includes a GBP ID translator. In the example of FIG. 1, the border gateway device 111 includes a GBP ID translator 181, and the border gateway device 112 includes a GBP ID translator 182. A GBP ID translator is used to translate between different GBP IDs in different domains, in scenarios where the different domains assign the different GBP IDs to the same group-based policy. For example, the domain 101 can assign a first GBP ID to a first group-based policy that is different from a second GBP ID assigned to the first group-based policy by the domain 102. As another example, the domain 101 can assign a GBP ID to a second group-based policy that is the same as the GBP ID assigned by the domain 102 to the second group-based policy.

Generally, a group-based policy is applied for one or more entities of a respective group. Different group-based policies may be applied for different groups of entities. Entities may be assigned to a group based on one or more criteria, including any or some combination of the following: a role of the entity (e.g., guest, employee, human resource department member, information technology support member, etc.), a location of the entity, or any other criteria. Within a domain, a group-based policy is assigned a GBP ID by a human administrator, a program, or a machine.

In accordance with some examples of the present disclosure, a network device includes a GBP ID tracing engine (GITE) to trace GBP IDs used at various nodes in a data path of a VXLAN tunnel. For example, the edge network device 121C includes a GITE 161, the edge network device 122A includes a GITE 162, the border gateway device 111 includes a GITE 171, and the border gateway device 112 includes a GITE 172. Although not shown, other network devices may similarly include GITEs.

In cases where the different domains use different GBP IDs to identify a given group-based policy, a GBP ID translator in a border gateway device can be used to translate between GBP IDs of the given group-based policy in the different domains. The translation of a GBP ID is based on a GBP ID translation rule configured in a respective border gateway device. In some examples, a VXLAN packet includes a VXLAN header that contains a Group Policy ID field that contains a GBP ID to identify a group-based policy. When a recipient border gateway device receives, from a source border gateway device, a VXLAN packet with a Group Policy ID field containing a particular GBP ID that identifies a particular group-based policy, the GBP ID translator of the recipient border gateway device can use a GBP ID translation rule to translate (if appropriate) the particular GBP ID to a different GBP ID. Note that if the domains of the recipient border gateway device and the source border gateway device use the same GBP ID for the particular group-based policy, then no GBP ID translation would be performed by the recipient border gateway device.

In some examples, the GBP ID translation rule may include an entry that maps an attribute value (e.g., a value of a role or another attribute) of an entity that transmitted a packet to a GBP ID of the particular group-based policy. Different attribute values (e.g., different roles) may be mapped to different BGP IDs of different group-based policies in respective entries of the GBP ID translation rule. Each domain is configured with a separate the GBP ID translation rule, and thus it may be possible for a first GBP ID translation rule in the domain 101 to map an attribute value (e.g., role) to a first GBP ID, and a second GBP ID translation rule in the domain 102 to map the same attribute value (e.g., role) to a different second GBP ID.

In some cases, a GBP ID translation rule programmed into a border gateway device may be incorrect or may not have been updated. In other examples, a GBP ID translator may misbehave, or data errors may occur in the border gateway device. In any of the foregoing cases, it is possible that a GBP ID mistranslation may occur at a border gateway device. A mistranslation of a GBP ID can produce an invalid GBP ID or a GBP ID that identifies the wrong group-based policy. An egress edge network device that receives a VXLAN packet with a mistranslated GBP ID can behave as follows: (1) if the GBP ID is invalid, then the egress edge network device would drop the packet, which results in a communication error, or (2) if the GBP ID identifies the wrong group-based policy, then the egress edge network device may mishandle how the packet is to be processed (e.g., the egress edge network device may forward the packet to the destination endpoint device when the packet should have been dropped, or the egress edge network device may drop the packet when the packet should have been forwarded to the destination endpoint device).

In a specific example, it is assumed that the endpoint device 141 transmits a packet that is targeted to a destination device, such as the endpoint device 142. Note that the endpoint devices 141 and 142 are in different domains 101 and 102. In response to receiving the packet from the source endpoint device 141, the ingress edge network device 121C can determine that the packet is to be governed by a given group-based policy. As result, the VTEP 151 adds a source GBP ID (e.g., 190) to the GBP ID field of the VXLAN header as part of the encapsulation of the packet performed by the VTEP 151. The ingress edge network device 121C sends the VXLAN encapsulated packet towards the border gateway device 111. The VXLAN encapsulated packet can pass through the aggregation network device 131A or 131B.

In response to receiving the VXLAN encapsulated packet, the border gateway device 111 relays the VXLAN encapsulated packet containing the GBP ID 190 to the border gateway device 112 in the domain 102. In response to receiving the VXLAN encapsulated packet from the border gateway device 111, the border gateway device GBP ID translator 182 in the border gateway device 112 translates the GBP ID 190 to a different GBP ID (e.g., 192) used in the domain 102. After the translation of the GBP ID, the border gateway device 112 sends the VXLAN encapsulated packet with GBP ID 192 towards the egress edge network device 122A. The VXLAN encapsulated packet from the border gateway device 112 may pass through the aggregation network device 132A or 132B. The VTEP 152 in the egress edge network device 122A decapsulates the received VXLAN encapsulated packet, and applies the group-based policy identified by GBP ID 192 in the domain 102. The group-based policy that is applied can specify whether the packet is to be dropped or forwarded (or any other processing to be applied to the packet). If the group-based policy indicates that the packet is to be forwarded, the egress edge network device 122A forwards the packet to the endpoint device 142. If the group-based policy indicates that the packet is to be dropped, then the egress edge network device 122A drops the packet and does not forward the packet to the endpoint device 142.

In accordance with some examples of the present disclosure, to detect any GBP ID mistranslations that may have occurred, GITEs (GBP ID tracing engines) provided in various network devices support the tracing of GBP IDs used in different nodes along a data path of a VXLAN tunnel. In some examples, a GITE in an edge network device (e.g., the GITE 161 in the edge network device 121C) can initiate the GBP ID tracing by sending trace packets. Nodes in the data path of the VXLAN tunnel can respond to trace packets with respective response packets. The response packets can be used by the GITE 161 in the edge network device 121C to create (or update) a GBP ID trace record 108 that is stored in a memory 110 of the edge network device 121C. The GBP ID trace record 108 can be used by a troubleshooting system 114 to determine, based on the GBP ID trace record 108, whether a GBP ID mistranslation has occurred. The troubleshooting system 114 may be implemented with one or more computers. In some examples, the troubleshooting system 114 may also initiate a remediation action to address a detected GBP ID mistranslation, including any or some combination of the following: isolating a particular node or segment of a network environment, issue an alert of the GBP ID mistranslation to a source or destination endpoint device or to any other entity, or any other remediation action to fix communication errors or to protect against a potential security breach.

In other examples, instead of creating the GBP ID trace record 108 in the edge network device 121C, the GITE 161 can trigger the creation of the GBP ID trace record 108 at a different system that is separate from the edge network device 121C (e.g., the troubleshooting system 114 or another system). The GITE 161 can send GBP IDs (and other information) included in response packets to the separate system, which can create the GBP ID trace record 108.

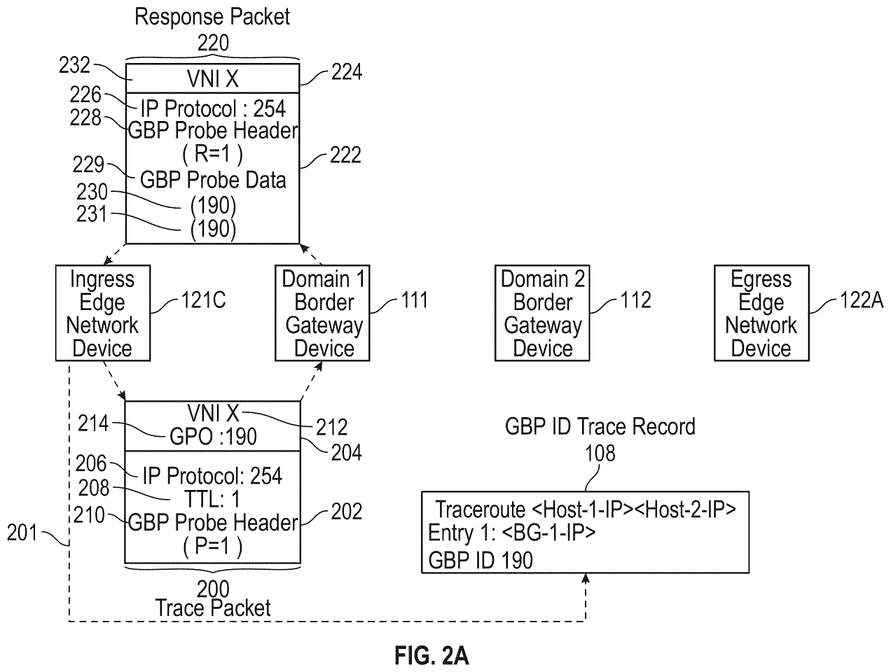

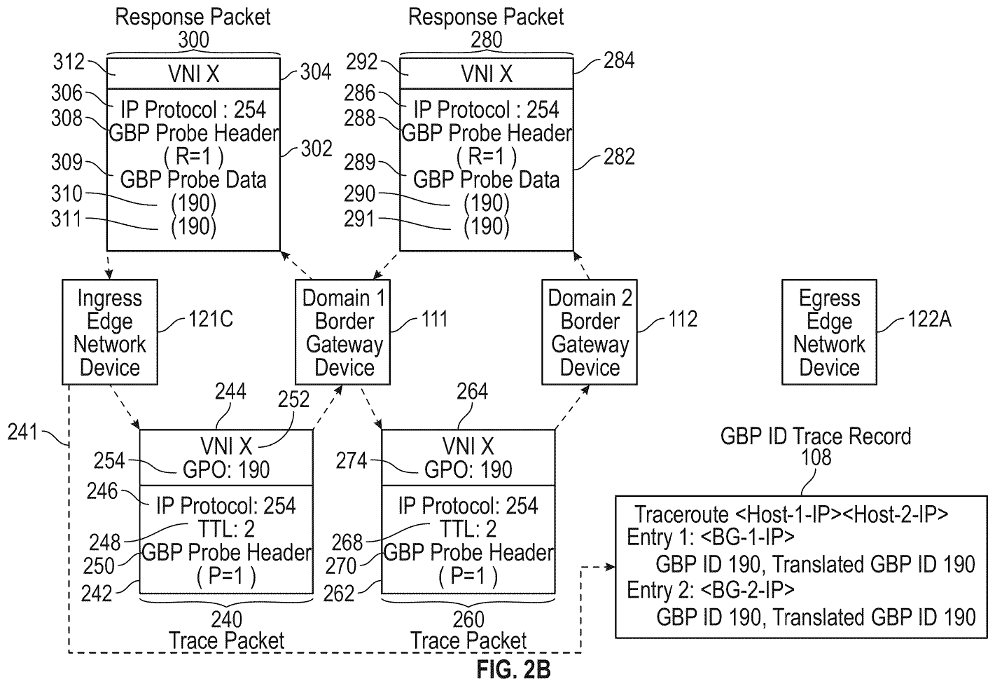

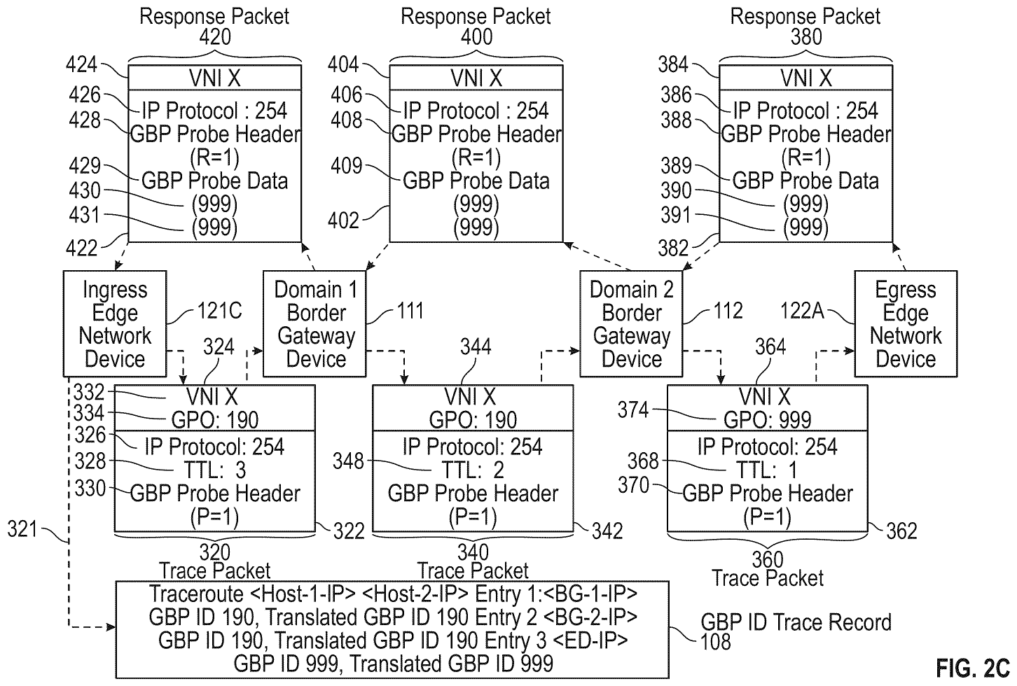

An example GBP ID tracing is discussed in connection with FIG. 2A to FIG. 2C. In some examples, GITEs employ a GBP ID traceroute functionality to perform the GBP ID tracing. A “traceroute” refers to a data path through which tracing is performed.

In a specific example, the GBP ID traceroute functionality uses an experimental protocol based on the experimental code point 254 described in Request for Comments (RFC) 4727, entitled “Experimental Values in IPv4, IPv6,ICMPv4, ICMPv6, UDP, and TCP Headers,” dated November 2006. The IP experimental protocol includes the experimental code in an IP header of an IP packet. The presence of the experimental code (e.g., 254) in the IP header indicates that the IP packet is transmitted for purposes of performing a test or experiment, which in some examples of the present disclosure includes the GBP ID tracing.

As shown in FIG. 2A, a trace packet 200 sent by the ingress edge network device 121C includes an inner packet 202 encapsulated by a VXLAN header 204, which is one of the headers of an outer packet. An inner packet is a packet encapsulated with outer header(s) of an outer packet. An IP header of the inner packet 202 includes an IP protocol field 206 set to the experimental code point 254, and a time to live (TTL) field 208 set to the value 1.

Packets used for GBP ID tracing according to the GBP ID traceroute functionality can include GBP probe information, which can include a GBP probe header or both a GBP probe header and GBP probe data. A trace packet includes a GBP probe header (but not GBP probe data). A response packet sent in response to a trace packet includes both a GBP probe header and GBP probe data. In the example of FIG. 2A, the inner packet 202 of the trace packet 200 includes a GBP probe header 210.

In more specific examples, a trace packet and a response packet can include Internet Control Message Protocol (ICMP) packets according to the ICMP protocol for performing diagnostics. For IPv4, ICMP is described by RFC 792, entitled “Internet Control Message Protocol,” dated September 1981. For IPv6, ICMP is described by RFC 4443, entitled “Internet Control Message Protocol (ICMPv6) for the Internet Protocol Version 6 (IPv6) Specification,” dated March 2006. In other examples, trace packets and response packets can be according to other protocols (whether standardized, open source, or proprietary) for performing diagnostics in a network environment.

The GBP ID traceroute functionality uses the TTL field in the IP header. Normally, TTL is used to prevent packets from being forwarded forever when there is a routing loop. Whenever an IP packet is forwarded by a router, the TTL is decreased by 1. When the TTL reaches zero, the IP packet will be discarded by the router. The GBP ID traceroute functionality according to some examples of the present disclosure sends a series of trace packets with increasing TTL values to trigger nodes in a path of a VXLAN tunnel to respond with response packets containing GBP IDs used by the nodes. In the example of FIG. 2A, the nodes in the data path of the VXLAN tunnel include the ingress edge network device 121C, the border gateway device 111, the border gateway device 112, and the egress edge network device 122A.

A first trace packet of the series of trace packets has a TTL set to 1, a second trace packet of the series of trace packets has a TTL set to 2, and so forth. More generally, the M^{th} (where M≥1) trace packet of the series of trace packets has a TTL set to M, which represents where in the series the trace packet is located. The trace packets of the series are successively sent (with TTL incremented by 1 with each trace packet) until the last of the trace packets reaches the egress edge network device 122A.

The VXLAN header 204 of the trace packet 200 includes a virtual network identifier (VNI) field 212 that includes a VNI that identifies a Layer 2 segment. The example value of the VNI in the VNI field 212 is VNI X. A VNI is mapped to a virtual local area network (VLAN); in other words, given a specific VNI, a VTEP can identify the corresponding VLAN, such as based on mapping information that correlates VNIs to VLANs (or more specifically, identifiers of VLANs). The combination of a VNI and an address (e.g., an IP address) of a VTEP (e.g., a VTEP in an edge network device) may uniquely identify a VXLAN tunnel. Note that there may be multiple VNIs used between a pair of VTEPs, e.g., the multiple VNIs identify respective VLANs. To uniquely identify a tunnel, a combination of a VNI and an address of a VTEP is used.

The VXLAN header 204 of the trace packet 200 also includes a Group Policy Option (GPO) field 214, which is also referred to as a Group Policy ID field. In the example of FIG. 2A, the GPO field 214 includes a source GBP ID 190, which identifies a source group-based policy. A “source” group-based policy refers to a group-based policy applied by a domain from which a packet was sent.

In some examples, the GBP probe header 210 in the trace packet 200 includes the elements set forth in Table 1.

TABLE 1

| | | |
|---|---|---|
| x x x x x S R P | Next Header | Other Field(s) |

The GBP probe header 210 includes an S indicator (e.g., a bit or collection of bits), an R indicator (e.g., a bit or collection of bits), a P indicator (e.g., a bit or collection of bits), a Next Header field that refers to the next header of the inner packet, and other field(s). The P indicator if set by a GITE to an active value (e.g., “1”) indicates that the packet containing the P indicator is a probe request for initiating GBP ID tracing according to some examples of the present disclosure; such a packet is a trace packet. The P indicator if set to an inactive value (e.g., “0”) indicates that the packet containing the P indicator is not a probe request.

The R indicator if set by the GITE to an active value (e.g., “1”) indicates that the packet containing the R indicator is a probe reply that responds to a probe request. Such a packet is a response packet that is responsive to a trace packet. The R indicator if set to an inactive value (e.g., “0”) indicates that the packet containing the R indicator is not a probe reply.

The S indicator if set by the GITE to an active value (e.g., “1”) indicates that the GBP ID tracing should stop. For example, the S indicator is set to the active value in a response packet by an egress edge network device receiving a trace packet from an ingress edge network device. The S indicator if set to an inactive value (e.g., “0”) indicates that the GBP ID tracing should continue, e.g., the ingress edge network device would continue to send the next trace packet in the series of trace packets.

The Next Header field includes a reference to a next header in the inner packet 202 if the next header is present. For example, the Next Header field in a response packet (that is responsive to a trace packet) includes a reference to a header containing GBP probe data. An example response packet 220 is shown in FIG. 2A. The Next Header field contains a null value if there is not a next header; for example, a trace packet includes a GBP probe header but not GBP probe data.

The values of the IP protocol field 206, the TTL field 208, and the GBP probe header 210 in the trace packet 200 are set by the GITE 161 of the ingress edge network device 121C. The GITE 161 sets the P indicator in the GBP probe header 210 to the active value (e.g., “1”).

The ingress edge network device 121C initiates GBP tracing for any endpoint device (including 141) connected to the ingress edge network device 121C. The ingress edge network device 121C performs a lookup of a host table (not shown) in the ingress edge network device 121C to determine how to reach a destination endpoint device, such as 142 in the domain 102. The host table includes an entry that identifies a border gateway device (in this case 111) in the VXLAN tunnel to use to reach the domain 102. Based on the host table lookup, the ingress edge network device 121C produces the inner packet 202 that has the following header values: a destination Media Access Control (MAC) address of the border gateway device 111, a source MAC address of the ingress edge network device 121C, a destination IP address of the destination endpoint device 142, a source IP address of the source endpoint device 141, the IP protocol field 206 set to the experimental code point 254, the TTL field 208 set to 1, and the GBP probe header 210 with P=1. The ingress edge network device 121C encapsulates the inner packet 202 with the VXLAN header 204 and sends the VXLAN encapsulated packet to the border gateway device 111.

The trace packet 200 sent by the ingress edge network device 121C is received by the border gateway device 111. In the example of FIG. 2A to FIG. 2C, it is assumed that an aggregation network device through which a packet traverses does not decrease TTL values.

In response to receiving the trace packet 200, the border gateway device 111 decapsulates the trace packet 200 (by removing the VXLAN header 204) to access the inner packet 202. As noted above, the destination MAC address of the inner packet 202 is set to the MAC address of the border gateway device 111, which indicates to the border gateway device 111 that the border gateway device 111 is a recipient that is to process the inner packet 202. The border gateway device 111 decrements the TTL value in the TTL field 208 (from 1 to 0). As a result, the inner packet 202 is dropped by the border gateway device 111. The GITE 171 in the border gateway device 111 responds to the probe request indicated by the P indicator of the GBP probe header 210 by generating a probe reply. The probe reply is carried in an inner packet 222 of the response packet 220. The border gateway device 111 encapsulates the inner packet 222 with a VXLAN header 224 to produce the response packet 220. The VXLAN header 224 has a VNI field 232 set to VNI X (the same VNI carried in the trace packet 200).

The inner packet 222 includes an IP protocol field 226 set to the experimental code point 254, and a GBP probe header 228 with the R indicator set to the active value (e.g., “1”) to indicate that the packet includes a probe reply. The Next_Header field in the GBP probe header 228 refers to the GBP probe data 229 in the inner packet 222.

In some examples, GBP probe data includes the elements set forth in Table 2.

TABLE 2

| | |
|---|---|
| x x x x x R A D | Received Source GBP ID |
| Domain Scope | Translated Source GBP ID |

The GBP probe data includes an R indicator (e.g., a bit or collection of bits), an A indicator (e.g., a bit or collection of bits), a D indicator (e.g., a bit or collection of bits), a Received Source GBP ID field, and a Translated Source GBP ID field.

The R indicator in the GBP probe data if set to an active value (e.g., “1”) indicates that GBP relay functionality is enabled. The R indicator in the GBP probe data if set to an inactive value (e.g., “0”) indicates that the GBP relay functionality is disabled. The GBP relay functionality refers to relaying a GBP ID in a received VXLAN encapsulated packet to an outbound VXLAN encapsulated packet, which can be performed at the border gateway device 111 or 112. For example, the border gateway device 111 receives a VXLAN encapsulated packet with GBP-ID X from the edge network device 121C. After decapsulating the received VXLAN encapsulated packet and making a forwarding decision, the border gateway device 111 generates an outbound VXLAN encapsulated packet containing GBP-ID X, and sends the outbound VXLAN encapsulated packet to the border gateway device 112. The border gateway device 112 can similarly perform GBP relay in the other direction.

The A indicator if set to an active value (e.g., “1”) indicates that a local group-based policy exists in the domain of the network device that sent the response packet. The A indicator if set to an inactive value (e.g., “0”) indicates that a local group-based policy does not exist in the domain of the network device that sent the response packet.

The D indicator if set to an active value (e.g., “1”) indicates that an egress edge network device (e.g., 122A) has dropped a trace packet received by the egress edge network device according to the group-based policy applied by the egress edge network device (assuming that a local group-based policy exists in the domain, e.g., A=1). The D indicator if set to an inactive value (e.g., “0”) indicates that a local group-based policy does not exist in the domain of the network device that the egress edge network device (e.g., 122A) has not dropped the trace packet received by the egress edge network device according to the group-based policy applied by the egress edge network device (e.g., the egress edge network device has forwarded the packet to the destination endpoint device).

The Domain Scope field of the GBP probe data includes an identifier of a domain (domain ID). The Received Source GBP ID field includes a source GBP ID received by a border gateway device, and a Translated Source GBP ID field includes a translated source GBP ID (if any translation is performed)

In the example of FIG. 2A, the GBP probe data 229 in the response packet 220 sent by the border gateway device 111 to the ingress edge network device 121C includes the following: the Domain Scope field set to the domain ID of the domain 101; the Received Source GBP ID field 230 set to source GBP ID 190 (which is the source GBP ID received by the border gateway device 111 in the GPO field 214 of the trace packet 200; and the Translated Source GBP ID field 231 set either to the source GBP ID 190 or to a null value to indicate that a translation was not performed.

In response to receiving the response packet 220, the ingress edge network device 121C decapsulates the response packet 220 by removing the VXLAN header 224, and extracts the GBP probe data 229 from the inner packet 222. The GITE 161 in the ingress edge network device 121C creates or updates (at 201) the trace record 108, including adding, to entry 1 of the trace record 108, the IP address (BG-1-IP) of the border gateway device 111, the received source GBP ID 190 from the Received Source GBP ID field 230 of the response packet 220, and the translated source GBP ID 190 from the Translated Source GBP ID field 231 of the response packet 220. Note that other information from the GBP probe data 229 can also be added to entry 1 of the trace record 108.

The trace record 108 contains traceroute information including the IP address of the source endpoint device 141 (e.g., Host-1-IP) and an IP address of the destination endpoint device 142 (e.g., Host-2-IP) for identifying a specific traceroute. The entries added to the trace record 108 are for this identified traceroute between the source endpoint device 141 and the destination endpoint device 142. The GITE 161 can generate other trace records for other traceroutes between other endpoint devices.

Since the response packet 220 was received from the border gateway device 111 and not an egress edge network device, the GITE 161 makes a determination that another trace packet of the series of trace packets is to be sent. A response packet from an egress edge network device would have the S indicator in a GBP probe header of the response packet set to an active value to indicate that the GBP ID tracing is to stop. Note that the GITE 161 continues to successively send the trace packets of the series until a trace packet reaches the egress edge network device 122A in the domain 102.

As shown in FIG. 2B, the ingress edge network device 121C generates a trace packet 240 that includes an inner packet 242 and a VXLAN header 244. The VXLAN header 244 includes a VNI field 252 set to VNI X, and a GPO field 254 set to BGP ID 190 (these values are the same as in the trace packet 200).

The GITE 161 sets the following values in the inner packet 242: an IP protocol field 246 set to the experimental code point 254, a TTL field 248 set to 2 (since the trace packet 240 is the second trace packet in the series of trace packets), and the P indicator in a GBP probe header 250 to the active value (e.g., “1”).

The ingress edge network device 121C sends the trace packet 240 to the border gateway device 111, which decapsulates the trace packet 240 (by removing the VXLAN header 244) to access the inner packet 242. The border gateway device 111 decrements the TTL value in the TTL field 248 (from 2 to 1). The border gateway device 111 then produces a trace packet 260 by encapsulating an inner packet 262 with a VXLAN header 264 that contains the same information as the VXLAN header 244. The inner packet 262 is identical to the inner packet 242 except TTL has been decremented to 1 in a TTL field 268 of the inner packet 262.

Based on a lookup of a host table in the border gateway device 111, the border gateway device 111 of the domain 101 determines that the trace packet 260 is to be forwarded in the VXLAN tunnel to the border gateway device 112 of the domain 102.

In response to receiving the trace packet 260, the border gateway device 112 decapsulates the trace packet 260 (by removing the VXLAN header 264) to access the inner packet 262. The border gateway device 111 decrements the TTL value in the TTL field 268 (from 1 to 0). As a result, the inner packet 262 is dropped by the border gateway device 112. The GITE 172 in the border gateway device 112 responds to the probe request indicated by the P indicator of a GBP probe header 270 in the inner packet 262 by generating a probe reply. The probe reply is carried in an inner packet 282 of a response packet 280 that is generated by the border gateway device 112 in response to the trace packet 260. The border gateway device 112 encapsulates the inner packet 282 with a VXLAN header 284 to produce the response packet 280. The VXLAN header 284 has a VNI field 292 set to VNI X (the same VNI carried in the trace packet 260).

The inner packet 282 includes an IP protocol field 286 set to the experimental code point 254, and a GBP probe header 288 with the R indicator set to the active value (e.g., “1”) to indicate that the packet includes a probe reply. The Next_Header field in the GBP probe header 288 refers to the GBP probe data 289 in the inner packet 282.

In the example of FIG. 2B, the GBP probe data 289 in the response packet 280 sent by the border gateway device 112 to the border gateway device 111 includes the following: the Domain Scope field set to the domain ID of the domain 102; the Received Source GBP ID field 290 set to source GBP ID 190 (which is the source GBP ID received by the border gateway device 112 in a GPO field 274 of the trace packet 260; and the Translated Source GBP ID field 291 set either to the source GBP ID 190 or to a null value to indicate that a translation was not performed. Note that because the border gateway device 112 dropped the inner packet 262, no GBP ID translation would be performed by the border gateway device 112.

In response to the response packet 280, the border gateway device 111 sends a response packet 300 to the ingress edge network device 121C. The response packet 300 includes an inner packet 302 and a VXLAN header 304. The VXLAN header 304 includes a VNI field 312, which contains the same value (VNI X) as a VNI field 292 in the VXLAN header 284 of the response packet 280. The inner packet 302 includes an IP protocol field 306, a GBP probe header 308, and GBP probe data 309, which contain the same content as the respective IP protocol field 286, a GBP probe header 288, and GBP probe data 289 of the response packet 280.

In response to receiving the response packet 300, the ingress edge network device decapsulates the response packet 300 by removing the VXLAN header 304, and extracts the GBP probe data 309 from the inner packet 302. The GITE 161 in the ingress edge network device 121C updates (at 241) the trace record 108, including adding, to entry 1 of the trace record 108, the IP address (BG-2-IP) of the border gateway device 112, the received source GBP ID 190 from a Received Source GBP ID field 310 of the response packet 300, and the translated source GBP ID 190 from a Translated Source GBP ID field 311 of the response packet 300. Note that other information from the GBP probe data 309 can also be added to entry 2 of the trace record 108.

Since the response packet 300 was received from the border gateway device 112 and not an egress edge network device, the GITE 161 makes a determination that another trace packet of the series of trace packets is to be sent. Note that the GITE 161 continues to successively send the trace packets of the series until a trace packet reaches the egress edge network device 122A in the domain 102.

As shown in FIG. 2C, the ingress edge network device 121C generates a trace packet 320 that includes an inner packet 322 and a VXLAN header 324. The VXLAN header 324 includes a VNI field 332 set to VNI X, and a GPO field 334 set to BGP ID 190 (these values are the same as in the trace packet 200).

The GITE 161 sets the following values in the inner packet 322: an IP protocol field 326 set to the experimental code point 254, a TTL field 328 set to 3 (since the trace packet 320 is the third trace packet in the series of trace packets), and the P indicator in a GBP probe header 330 to the active value (e.g., “1”).

The ingress edge network device 121C sends the trace packet 320 to the border gateway device 111, which decapsulates the trace packet 320 and decrements the TTL value in the TTL field 328 (from 3 to 2). The border gateway device 111 then produces a trace packet 340 by encapsulating an inner packet 342 with a VXLAN header 344 that contains the same information as the VXLAN header 324. The inner packet 342 is identical to the inner packet 322 except TTL has been decremented to 2 in a TTL field 348 of the inner packet 342.

Based on a lookup of a host table in the border gateway device 111, the border gateway device 111 of the domain 101 determines that the trace packet 340 is to be sent over the VXLAN tunnel to the border gateway device 112 of the domain 102. In response to receiving the trace packet 340, the border gateway device 112 decapsulates the trace packet 340 and decrements the TTL value in the TTL field 348 (from 2 to 1). The GBP ID translator 182 in the border gateway device 112 also translates the GBP ID 190 to a different GBP ID 999. The GBP ID 999 is an incorrect GBP ID due to a mistranslation by the GBP ID translator 182. The GBP ID translator 182 should have translated the GBP ID 190 to a different GBP ID value.

The border gateway device 112 generates a trace packet 360, which includes an inner packet 362 and a VXLAN header 364. A TTL field 368 in the inner packet 362 is set to 1.

Based on a lookup of a host table in the border gateway device 112, the border gateway device 112 determines that the trace packet 360 is to be sent to the egress edge network device 122A. In response to receiving the trace packet 360, the egress edge network device 122A decapsulates the trace packet 360 and decrements the TTL value in the TTL field 368 (from 1 to 0). As a result of decrementing TTL to 0, the inner packet 362 is dropped by the egress edge network device 122A. The GITE 162 in the egress edge network device 122A responds to the probe request indicated by the P indicator of a GBP probe header 370 in the inner packet 362 by generating a probe reply. The probe reply is carried in an inner packet 382 of a response packet 380 that is generated by the egress edge network device 122A in response to the trace packet 360. The egress edge network device 122A encapsulates the inner packet 382 with a VXLAN header 384 to produce the response packet 380. The VXLAN header 384 has a VNI field 392 set to VNI X (the same VNI carried in the trace packet 360).

The inner packet 382 includes an IP protocol field 386 set to the experimental code point 254, and a GBP probe header 388 with the R indicator set to the active value (e.g., “1”) to indicate that the packet includes a probe reply, and the S indicator set to the active value (e.g., “1”) to indicate that the GBP ID tracing should stop. The Next_Header field in the GBP probe header 388 refers to the GBP probe data 389 in the inner packet 382.

In the example of FIG. 2C, the GBP probe data 389 in the response packet 380 sent by the egress edge network device 122A to the border gateway device 112 includes the following: the Domain Scope field set to the domain ID of the domain 102; the Received Source GBP ID field 390 set to source GBP ID 999 (which is the source GBP ID received by the egress edge network device 122A in a GPO field 374 of the trace packet 360); and the Translated Source GBP ID field 491 set to the translated source GBP ID 999. In addition, the GITE 162 sets the D indicator in the GBP probe data 389 to either the active value or the inactive value to indicate what policy action (drop or forward) was taken by the egress edge network device 122A based on the group-based policy identified by the translated source GBP ID 999.

In response to the response packet 380, the border gateway device 112 sends a response packet 400 to the border gateway device 111. The response packet 400 includes an inner packet 402 and a VXLAN header 404. The inner packet 402 includes an IP protocol field 406, a GBP probe header 408, and GBP probe data 409, which contain the same content as the respective IP protocol field 386, a GBP probe header 388, and GBP probe data 389 of the response packet 380.

In response to the response packet 400, the border gateway device 111 sends a response packet 420 to the ingress edge network device 121C. The response packet 420 includes an inner packet 422 and a VXLAN header 424. The inner packet 422 includes an IP protocol field 426, a GBP probe header 428, and GBP probe data 429, which contain the same content as the respective IP protocol field 406, a GBP probe header 408, and GBP probe data 409 of the response packet 400.

In response to receiving the response packet 420, the ingress edge network device decapsulates the response packet 420 and extracts the GBP probe data 429 from the inner packet 422. The GITE 161 in the ingress edge network device 121C updates (at 321) the trace record 108, including adding, to entry 3 of the trace record 108, the IP address (ED-IP) of the egress edge network device 122A, the source GBP ID 999 from a Received Source GBP ID field 430 of the response packet 420, and the translated GBP ID 999 from a Translated Source GBP ID field 431 of the response packet 420. Further, the GITE 161 adds information of the policy action (e.g., the D indicator of the GBP probe data 429 set to the active or inactive value) to entry 3 of the trace record 108. Note that other information from the GBP probe data 429 can also be added to entry 3 of the trace record 108.

At this point, the trace record 108 (with entries 1, 2, and 3) contain BGP IDs used by all the nodes in the data path of the VXLAN tunnel between the VTEP 151 in the ingress edge network device 121C and the VTEP 152 in the egress edge network device 122A. Additionally, the trace record 108 contains information of the policy action (represented by the D indicator) taken by the egress edge network device 122A based on the group-based policy identified by the translated BGP ID 999.

The egress edge network device 122A can provide the trace record 108 to another system, such as the troubleshooting system 114, to detect any issues and to perform any remediation actions in response to the detected issues.

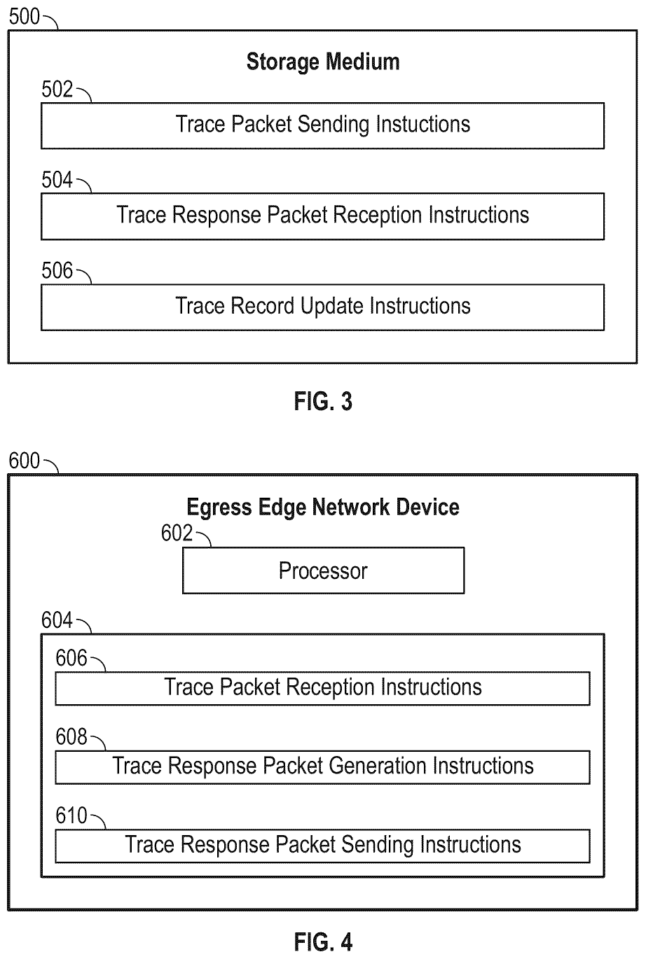

FIG. 3 is a block diagram of a non-transitory machine-readable or computer-readable storage medium 500 storing machine-readable instructions that upon execution cause a first network device in a first domain to perform various actions. An example of the first network device is the edge network device 121C of FIG. 1.

The machine-readable instructions include trace packet sending instructions 502 to send, from the first network device to a first gateway device of the first domain, a trace packet targeted to a destination device in a second domain. The trace packet includes a first virtual tunnel header and a probe request, and the first virtual tunnel header contains a first policy identifier. An example of the first gateway device is the border gateway device 111 in the domain 101 of FIG. 1. An example of the virtual tunnel header is a VXLAN header. The probe request can be represented by the P indicator in a GBP probe header being set to the active value.

The machine-readable instructions include trace response packet reception instructions 504 to receive, at the first network device, a response packet including a second virtual tunnel header and probe information. The probe information contains a translated policy identifier field to store any translated policy identifier produced by a second gateway device of the second domain. An example of the second gateway device is the border gateway device 112 in the domain 102 of FIG. 1. The first gateway device and the second gateway device are in a path of a virtual tunnel between the first network device in the first domain and a second network device in the second domain. The probe information can include a GBP probe header and GBP probe data.

The machine-readable instructions include trace record update instructions 506 to initiate, by the first network device, an update of a trace record by adding a policy identifier contained in the translated policy identifier field to support diagnostics relating to a policy identifier mistranslation. In some examples, the first network device updates the trace record. In other examples, the first network device sends probe information to another system to update the trace record.

In some examples, the response packet includes information of a policy action applied at the second network device in the second domain based on a policy identified by the policy identifier contained in the translated policy identifier field. The update of the trace record adds the information of the policy action to the trace record.

In some examples, the trace packet is a first trace packet, and the response packet is a first response packet. The first trace packet includes an IP header having a TTL field set to a first value. The probe information of the first response packet includes a probe stop indication (e.g., the S indicator of the GBP probe header set to the active value) to indicate that the first trace packet has reached an egress edge network device, the egress edge network device being the second network device.

In some examples, the machine-readable instructions set a TTL field in an IP header in a second trace packet to a second value that is less than the first value, the first network device sends, to the first gateway device, the second trace packet targeted to the destination device in the second domain. The second trace packet includes a virtual tunnel header and a probe request, where the virtual tunnel header of the second trace packet contains the first policy identifier, and where the second trace packet is sent before the first trace packet. The first network device receives a second response packet including a virtual tunnel header and probe information, the probe information of the second response packet containing a translated policy identifier field, and the probe information of the second response packet is without the probe stop indication. The sending of the first trace packet is responsive to the probe information of the second response packet being without the probe stop indication.

In some examples, the probe information of the first response packet includes a probe stop indicator (e.g., the S indicator in GBP probe data) set to a first value to provide the probe stop indication. The probe information of the second response packet includes the probe stop indicator set to a different second value to indicate that the second response packet is without the probe stop indication.

In | some examples, the first network device initiates a further update of the trace record by adding a policy identifier contained in the translated policy identifier field of the second response packet.

In some examples, the policy action includes one of dropping the trace packet or forwarding the trace packet.

FIG. 4 is a block diagram of an egress edge network device 600 of a first domain, where the egress edge network device 600 includes a hardware processor 602 (or multiple hardware processors). The egress edge network device 600 further includes a storage medium 604 storing machine-readable instructions executable on the hardware processor 602 to perform various tasks.

The machine-readable instructions in the storage medium 604 include trace packet reception instructions 606 to receive, at the egress edge network device 600 from a first gateway device of the first domain, a trace packet targeted to a destination device in the first domain. The trace packet includes a first virtual tunnel header and a probe request, the first virtual tunnel header containing a first policy identifier. The destination device is connected to the egress edge network device 600, where the trace packet was sent from an ingress edge network device in a second domain different from the first domain.

The machine-readable instructions in the storage medium 604 include trace response packet generation instructions 608 to generate, at the egress edge network device 600 as a response to the trace packet, a response packet including a second virtual tunnel header and probe information containing a translated policy identifier field to store any translated policy identifier produced by the first gateway device of the first domain from a policy identifier produced by a second gateway device of the second domain. The first gateway device is connected to the second gateway device over a virtual tunnel.

The machine-readable instructions in the storage medium 604 include trace response packet sending instructions 610 to send, from the egress edge network device 600, the response packet to the first gateway device for forwarding by the first gateway device over the virtual tunnel and through the second gateway device to the ingress edge network device.

A hardware processor can include a microprocessor, a core of a multi-core microprocessor, a microcontroller, a programmable integrated circuit, a programmable gate array, or another hardware processing circuit. Machine-readable instructions executable on a hardware processor can refer to the instructions executable on a single hardware processor or the instructions executable on multiple hardware processors.

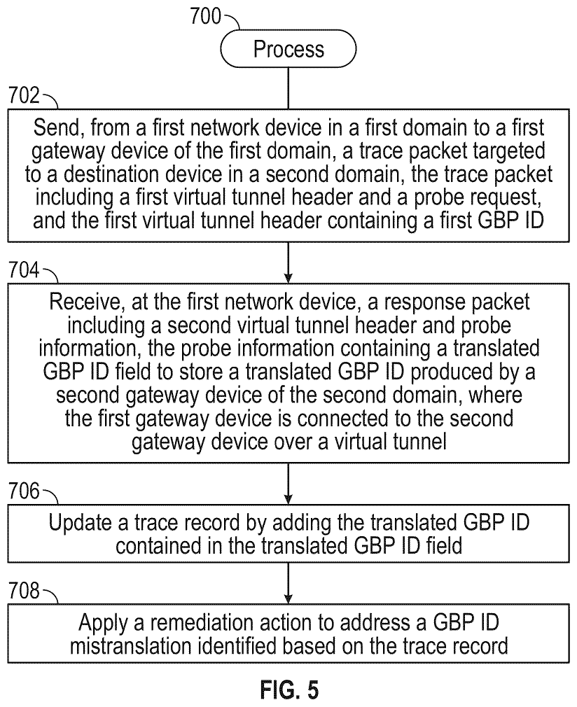

FIG. 5 is a flow diagram of a process 700 according to some examples. The process 700 includes sending (at 702), from a first network device in a first domain to a first gateway device of the first domain, a trace packet targeted to a destination device in a second domain, the trace packet including a first virtual tunnel header and a probe request, and the first virtual tunnel header containing a first GBP ID. The first network device can be an ingress edge network device.

The process 700 includes receiving (at 704), at the first network device, a response packet including a second virtual tunnel header and probe information, the probe information containing a translated GBP ID field to store a translated GBP ID produced by a second gateway device of the second domain. The first gateway device is connected to the second gateway device over a virtual tunnel, such as a VXLAN tunnel.

The process 700 includes updating (at 706) a trace record by adding a translated GBP ID contained in the translated GBP ID field. The trace record can be incrementally updated as response packets are received in response to a series of trace packets sent by the first network device.

The process 700 includes applying (at 708) a remediation action to address a GBP ID mistranslation identified based on the trace record. The remediation action can be performed by the troubleshooting system 114 of FIG. 1, for example.

A memory can be implemented using one or more memory devices, such as any or some combination of a dynamic random access memory (DRAM) device, a static random access memory (SRAM) device, a flash memory device, or any other type of memory device.

A “controller” or an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” or an “engine” can refer to a combination of one or more hardware processing circuits and machine-readable instructions (software and/or firmware) executable on the one or more hardware processing circuits.

A “translator” (such as the GBP ID translator 181 or 182 of FIG. 1) can also refer to one or more hardware processing circuits, or a combination of one or more hardware processing circuits and machine-readable instructions executable on the one or more hardware processing circuits.

A “packet” can refer to any unit of data that can be separately transmitted from another unit of data.

A storage medium (e.g., 500 in FIG. 3 or 604 in FIG. 4) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a first network device in a first domain to:
send, from the first network device to a first gateway device of the first domain, a trace packet targeted to a destination device in a second domain, the trace packet comprising a first virtual tunnel header and a probe request, the first virtual tunnel header containing a first policy identifier;
receive, at the first network device, a response packet comprising a second virtual tunnel header and probe information, the probe information containing a translated policy identifier field to store any translated policy identifier produced by a second gateway device of the second domain, the first gateway device and the second gateway device being in a path of a virtual tunnel between the first network device in the first domain and a second network device in the second domain; and
initiate, by the first network device, an update of a trace record by adding a policy identifier contained in the translated policy identifier field to support diagnostics relating to a policy identifier mistranslation.

2. The non-transitory machine-readable storage medium of claim 1, wherein the response packet comprises information of a policy action applied at the second network device in the second domain based on a policy identified by the policy identifier contained in the translated policy identifier field, and
wherein the update adds the information of the policy action to the trace record.

3. The non-transitory machine-readable storage medium of claim 2, wherein the trace packet is a first trace packet, and the response packet is a first response packet, the first trace packet comprising an Internet Protocol (IP) header having a time to live (TTL) field set to a first value, and wherein the probe information of the first response packet comprises a probe stop indication to indicate that the first trace packet has reached an egress edge network device, the egress edge network device being the second network device.

4. The non-transitory machine-readable storage medium of claim 3, wherein the instructions upon execution cause the first network device to:
set a TTL field in an IP header in a second trace packet to a second value that is less than the first value;
send, from the first network device to the first gateway device, the second trace packet targeted to the destination device in the second domain, the second trace packet comprising a virtual tunnel header and a probe request, the virtual tunnel header of the second trace packet containing the first policy identifier, wherein the second trace packet is sent before the first trace packet; and
receive, at the first network device, a second response packet comprising a virtual tunnel header and probe information, the probe information of the second response packet containing a translated policy identifier field, and the probe information of the second response packet is without the probe stop indication,
wherein the sending of the first trace packet is responsive to the probe information of the second response packet being without the probe stop indication.

5. The non-transitory machine-readable storage medium of claim 4, wherein the probe information of the first response packet comprises a probe stop indicator set to a first value to provide the probe stop indication, and the probe information of the second response packet comprises the probe stop indicator set to a different second value to indicate that the second response packet is without the probe stop indication.

6. The non-transitory machine-readable storage medium of claim 4, wherein the instructions upon execution cause the first network device to:
initiate, by the first network device, a further update of the trace record by adding a policy identifier contained in the translated policy identifier field of the second response packet.

7. The non-transitory machine-readable storage medium of claim 2, wherein the policy action comprises one of dropping the trace packet or forwarding the trace packet.

8. The non-transitory machine-readable storage medium of claim 1, wherein the first virtual tunnel header comprises a Virtual extensible LAN (VXLAN) header, and the virtual tunnel between the first gateway device and the second gateway device comprises a VXLAN tunnel.

9. The non-transitory machine-readable storage medium of claim 8, wherein the first and second domains comprise Ethernet Virtual Private Network (EVPN) domains.

10. The non-transitory machine-readable storage medium of claim 8, wherein the response packet is from the second network device in the second domain, and the response packet from the second network device passed through the second gateway device over the virtual tunnel to the first gateway device.

11. The non-transitory machine-readable storage medium of claim 10, wherein the first network device comprises a first VXLAN tunnel endpoint (VTEP), and the second network device comprises a second VTEP.

12. The non-transitory machine-readable storage medium of claim 1, wherein the probe request of the trace packet comprises a first inner packet encapsulated by the first virtual tunnel header, and the first inner packet comprises an Internet Protocol (IP) Protocol field set to an experimental code point.

13. The non-transitory machine-readable storage medium of claim 12, wherein the probe information of the response packet that is responsive to the trace packet comprises a second inner packet encapsulated by the second virtual tunnel header, and the second inner packet comprises an IP Protocol field set to the experimental code point.

14. An egress edge network device of a first domain, the egress edge network device comprising:
a processor; and
a non-transitory storage medium comprising instructions executable on the processor to:
receive, at the egress edge network device from a first gateway device of the first domain, a trace packet targeted to a destination device in the first domain, the trace packet comprising a first virtual tunnel header and a probe request, the first virtual tunnel header containing a first policy identifier, the destination device connected to the egress edge network device, and where the trace packet was sent from an ingress edge network device in a second domain different from the first domain;
generate, at the egress edge network device as a response to the trace packet, a response packet comprising a second virtual tunnel header and probe information containing a translated policy identifier field to store any translated policy identifier produced by the first gateway device of the first domain from a policy identifier produced by a second gateway device of the second domain, the first gateway device connected to the second gateway device over a virtual tunnel; and
send, from the egress edge network device, the response packet to the first gateway device for forwarding by the first gateway device over the virtual tunnel and through the second gateway device to the ingress edge network device.

15. The egress edge network device of claim 14, wherein the probe information further comprises a probe stop indication to indicate that the trace packet has reached the egress edge network device.

16. The egress edge network device of claim 14, wherein the probe information further comprises information of a policy action applied by the egress edge network device on the trace packet.

17. The egress edge network device of claim 14, comprising:
a first VXLAN tunnel endpoint (VTEP) to establish the virtual tunnel with a second VTP in the ingress edge network device.

18. A method comprising:
sending, from a first network device in a first domain to a first gateway device of the first domain, a trace packet targeted to a destination device in a second domain, the trace packet comprising a first virtual tunnel header and a probe request, the first virtual tunnel header containing a first group-based policy identifier (GBP ID);
receiving, at the first network device, a response packet comprising a second virtual tunnel header and probe information, the probe information containing a translated GBP ID field to store a translated GBP ID produced by a second gateway device of the second domain, the first gateway device and the second gateway device being in a path of a virtual tunnel between the first network device in the first domain and a second network device in the second domain;
updating a trace record by adding the translated GBP ID contained in the translated GBP ID field; and
applying a remediation action to address a GBP ID mistranslation identified based on the trace record.

19. The method of claim 18, wherein the updating of the trace record comprises adding information of a policy action performed by the second network device according to a group-based policy identified by the translated GBP ID.

20. The method of claim 18, further comprising:
determining, based on a probe stop indication in the probe information, that the trace packet reached the second network device, wherein the probe stop indication was added by the second network device responsive to receipt of the trace packet by the second network device.
